(19) United States
(12) Patent Application Publication
(10) Pub. No.: US 2026/0061591 A1
(43) Pub. Date: Mar. 5, 2026

(54) PIPE MARKER

(71) Applicant: Saveliy Gershfeld, Placentia, CA (US)

(72) Inventor: Saveliy Gershfeld, Placentia, CA (US)

(21) Appl. No.: 18/822,602

(22) Filed: Sep. 3, 2024

(51) Int. Cl. B25H 7/04

(52) U.S. Cl. CPC B25H 7/045

(57) ABSTRACT

A pipe marker imprints a double mark on a copper pipe used for heatless or torchless copper pipe connection in HVAC and refrigeration systems applications, such that the distance from any point between the double mark to the end of the pipe is sufficient to be inserted into the coupler for a strong, leak-proof connection between copper pipes. The pipe marker accommodates different diameters of the pipe and imprints the double mark at the correct location on the pipe based on the diameter.

### FIELD OF THE INVENTION

The present invention pertains to the field of pipe markers, and more particularly to the field of marking copper pipes for quality control when installing mechanically attached fittings on copper pipe connections for plumbing, heating, ventilation and air conditioning (HVAC) and refrigeration systems applications.

### BACKGROUND OF THE INVENTION

Copper pipes in HVAC and refrigeration systems are conventionally joined by the process known as brazing. Brazing involves melting a filler metal into the joint, which then cools and solidifies to form a strong, leak-proof connection. Brazing involves using torches to melt the filler metal. However, heatless or torchless copper pipe connections, also known as mechanically attached fittings, press fittings or push-to-connect fittings, offer advantages in HVAC and refrigeration systems applications due to their ease of use, safety and efficiency. This is especially true for situations where traditional brazing might be impractical or unsafe.

The heatless or torchless copper pipe connection method uses couplers between copper pipes that are pressed with a tool to form a strong, leak-proof connection. In this method, it is very important to maintain a minimum critical distance from the edge of the pipe to the edge of the coupler, such that a sufficient length of pipe is inserted into the coupler to maintain the connection. If the length of pipe inserted into the coupler is insufficient, the connection will fail. Each diameter of the pipe corresponds to the specific minimum critical distance. The critical distance is provided by the manufacturer of the couplers.

Conventionally, the distance from the pipe's end is marked with a felt pen after the coupler is inserted into the pipe end. The problem with this method is that when the pipes are already attached and the connection is inspected, the felt pen mark may had been erased. Another possibility is that a dishonest worker may reapply the felt pen mark on the pipe to make it look as though the coupler is attached correctly. What is needed, therefore, is a full-proof and fail-proof means for marking pipes'critical distance from the edge for the heatless or torchless copper pipe couplers or mechanically attached fittings.

### SUMMARY OF THE INVENTION

The present invention satisfies this need. The pipe marker according to this invention imprints a double mark on the pipe, such that the distance between any point between the double mark and the end of the pipe is no less than the critical distance corresponding to the diameter of the pipe. Put simply, if the pipe is inserted into the coupler up to any point between the double mark, the connection is secure. If both double marks are visible outside the coupler, the connection is defective.

### BRIEF DESCRIPTION OF THE DRAWING FIGURES

FIG. 1 shows an isometric view of a pipe marker according to this invention.

FIG. 2 shows an exploded isometric view of the pipe marker according to this invention.

FIG. 3 shows an isometric view of a portion of the pipe marker according to this invention and sectional views thereof.

FIG. 4 shows an isometric view of the pipe marker according to this invention in the process of use thereof with a large diameter pipe.

FIG. 5 shows an isometric view of the pipe marker according to this invention in the process of use thereof with a medium diameter pipe.

FIG. 6 shows an isometric view of the pipe marker according to this invention in the process of use thereof with a small diameter pipe.

FIG. 7 shows an isometric and elevation views of a blade assembly of the pipe marker according to this invention.

### DETAILED DESCRIPTION OF THE PREFERRED EMBODIMENT

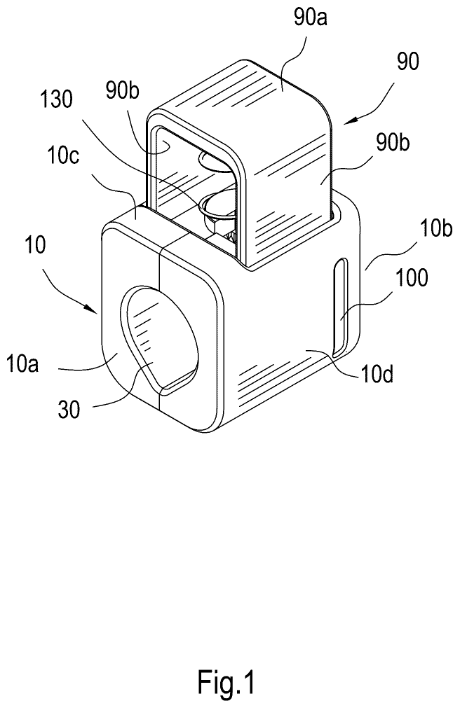

This invention will be better understood with reference to FIG. 1 through FIG. 7. The same numerals indicate the same elements in all drawing figures.

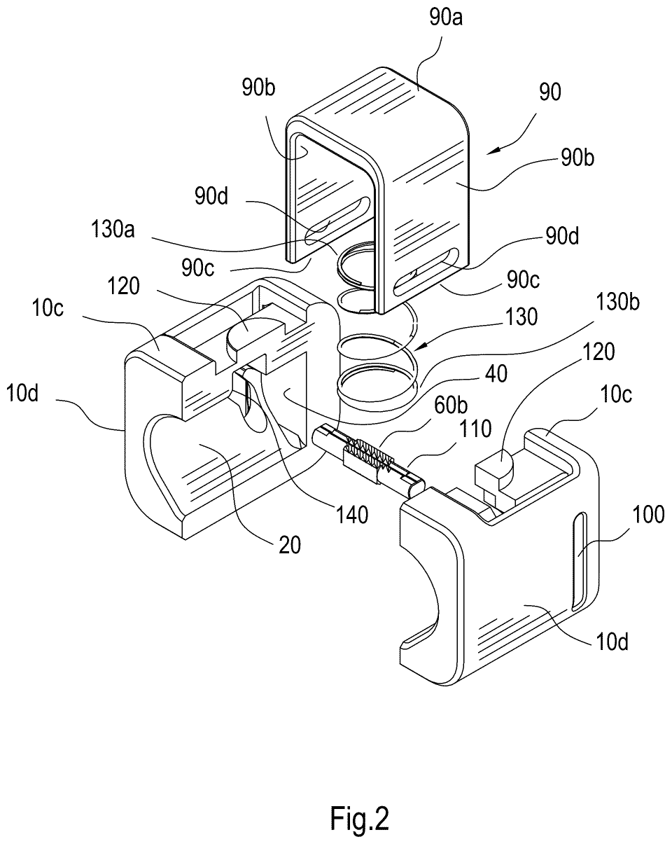

Viewing, simultaneously, FIG. 1 and FIG. 2, numeral 10 indicates a pipe marker assembly. Pipe marker assembly 10 comprises a front indicated by numeral 10a, a back indicated by numeral 10b, a top indicated by numeral 10c, and a pair of opposite sides indicated by numeral 10d.

Numeral 20 indicates an elongated chamber. Chamber 20 is disposed inside pipe marker assembly 10 and comprises an inlet indicated by numeral 30. Inlet 30 is disposed on front 10a.

Numeral 40 indicates a wall disposed near back 10b.

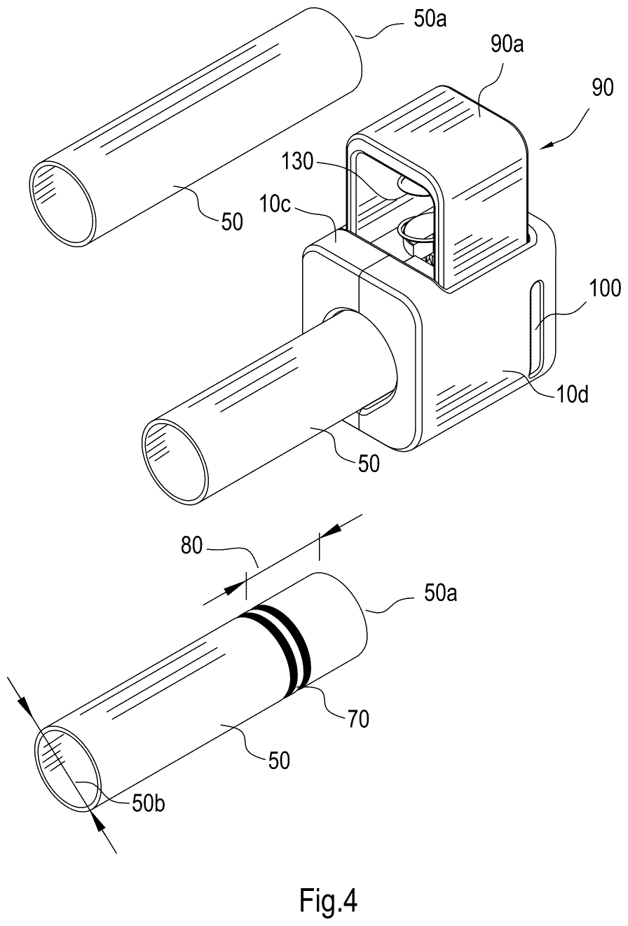

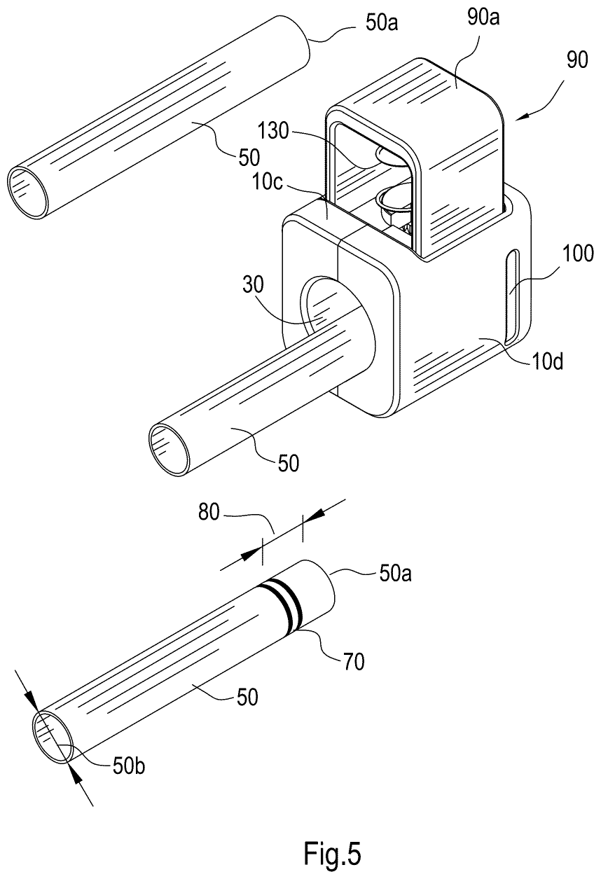

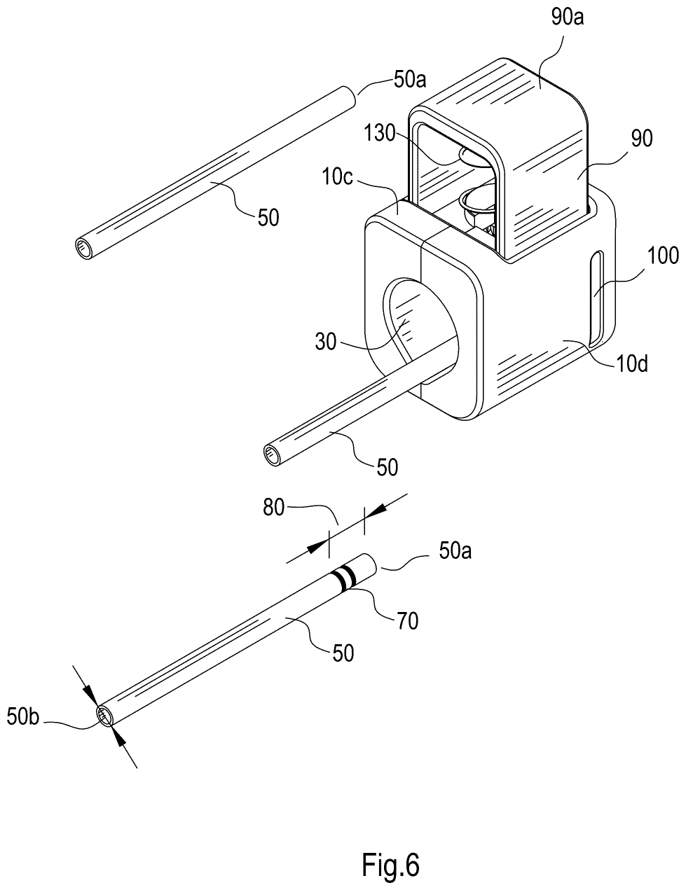

Viewing now, simultaneously, FIG. 4, FIG. 5 and FIG. 6, numeral 50 indicates a pipe. Pipe 50 comprises an end indicated by numeral 50a and a diameter indicated by numeral 50b. FIG. 4 shows pipe 50 with a large diameter 50b. FIG. 5 shows pipe 50 with a medium diameter 50b. FIG. 6 shows pipe 50 with a small diameter 50b. Chamber 20 is configured to receive a pipe 50 through inlet 30 and position end 50a abutting wall 40.

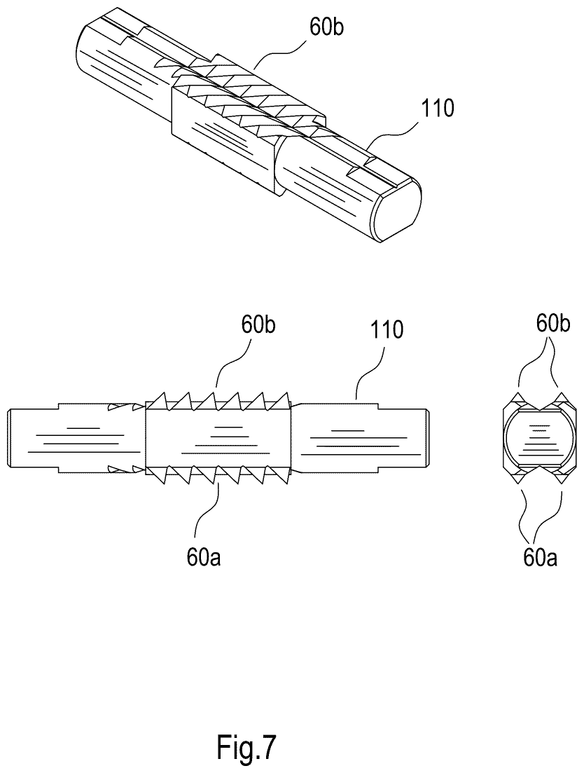

Viewing now, simultaneously, FIG. 1, FIG. 2, FIG. 4, FIG. 5, FIG. 6 and FIG. 7, numeral 60a indicates a down facing double blade. Down facing double blade 60a is spring loaded. Down facing double blade 60a is configured to imprint a double mark indicated by numeral 70 on pipe 50, such that the distance between any point between double mark 70 and end 50a is no less than a critical distance indicated by numeral 80, corresponding to diameter 50b. Larger diameter 50b corresponds to longer critical distance 80. Critical distance 80 shown in FIG. 4 is longer than critical distance 80 shown in FIG. 5. Critical distance 80 shown in FIG. 5 is longer than critical distance 80 shown in FIG. 6.

Viewing again, simultaneously, FIG. 1 and FIG. 2, numeral 90 indicates a C-shaped trigger. Trigger 90 comprises a base indicated by numeral 90a and arms indicated by numeral 90b. Arms 90b extend from base 90a and terminate in downward facing flanges indicated by numeral 90c.

Numeral 90d indicates slots. Slots 90d are disposed near and substantially parallel to flanges 90c.

Viewing again, simultaneously, FIG. 1, FIG. 2 and FIG. 7, numeral 110 indicates a guide bar. Guide bar 110 is integral with down facing double blade 60a. Slots 90d are configured to receive guide bar 110 therein and push upon guide bar 110.

Viewing, simultaneously, FIG. 1 and FIG. 2, numeral 120 indicates a spring holder. Spring holder 120 is disposed on top 10c. Numeral 130 indicates a spring. Spring 130 comprises a proximate end indicated by numeral 130a and a distal end indicated by numeral 130b. Proximate end 130a abuts base 90a. Spring holder 120 receives distal end 130b.

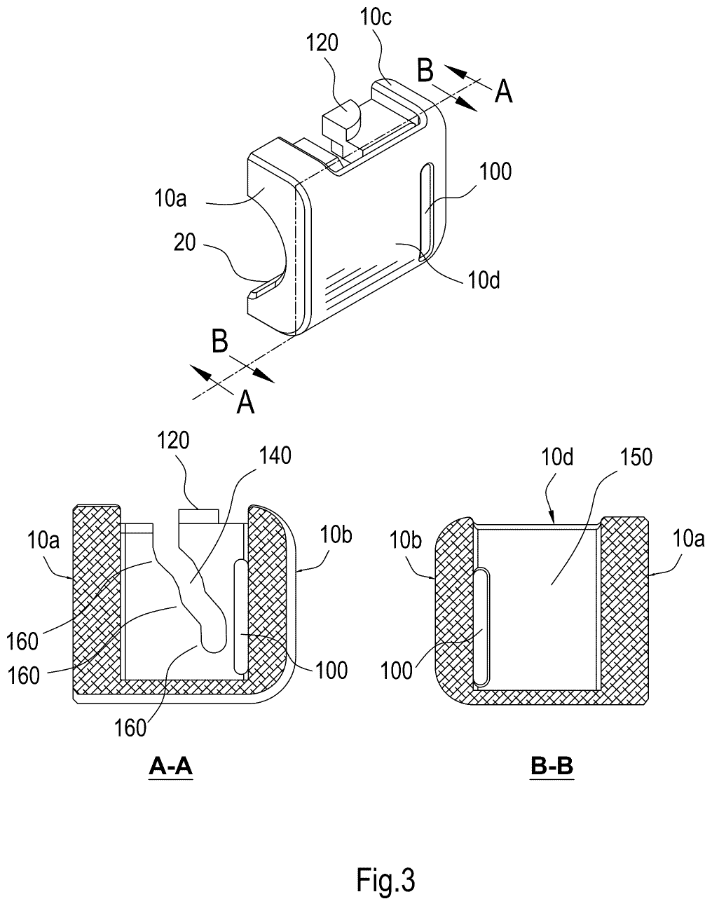

Viewing now FIG. 1 and FIG. 3, numeral 140 indicates a guide channel. A pair of symmetrical guide channels 140 is disposed in sides 10d. Guide channels 140 are configured to receiving and guiding guide bar 110 therein.

Numeral 150 indicates a recess. A pair of symmetrical recesses 150 are disposed near and parallel to sides 10d. Recesses 150 are configured to slidably receive arms 90b therein.

Guide channels 140 comprisa a plurality of detents indicated by numeral 160. The preferred embodiment shown in FIG. 1 through FIG. 7 has a total of three detents 160. Inlet 30 is shaped as an inverted teardrop.

Pipe 50 abutting the narrowest portion of the inverted teardrop permits each detent 160 to position down facing double blade 60a to imprint double mark 70 at no less than critical distance 80 corresponding to diameter 50b. Specifically, as shown in FIG. 4, FIG. 5 and FIG. 6, the user would insert pipe 50 into inlet 30 until pipe 50 abuts wall 40, push pipe 50 down until pipe 50 abuts the narrowest portion of the inverted teardrop, push upon trigger 90, turn pipe 50 back and forth, thus imprinting double mark 70 on pipe 50.

Viewing FIG. 1 through FIG. 6, numeral 100 indicates a window. Window 100 is disposed near and along wall 40. Window 100 permits observing end 50a abutting wall 40.

Viewing FIG. 7, in the preferred embodiment, guide bar 110 is a reversable member comprising an up facing double blade indicated by numeral 60b. Up facing double blade 60b is an additional blade to down facing double blade 60a. Up facing double blade 60b is disposed symmetrically to down facing double blade 60a on guide bar 110. Up facing double blade 60b is not used for marking pipe 50 while down facing double blade 60a is doing the job. However, when down facing double blade 60a wears out, guide bar 110 is reversed and up facing double blade 60b takes place of down facing double blade 60a.

In the preferred embodiment, down facing double blade 60a and up facing double blade 60b are serrated.

While the present invention has been described and defined by reference to the preferred embodiment of the invention, such reference does not imply a limitation on the invention, and no such limitation is to be inferred. The invention is capable of considerable modification, alteration, and equivalents in form and function, as will occur to those ordinarily skilled and knowledgeable in the pertinent arts. The depicted and described preferred embodiment of the invention is exemplary only, and is not exhaustive of the scope of the invention.

Consequently, the invention is intended to be limited only by the spirit and scope of the appended claims, giving full cognizance to equivalents in all respects.

We claim:

1. A pipe marker comprising:
a pipe marker assembly comprising a front, a back, a top, a pair of opposite sides;
an elongated chamber disposed inside the pipe marker assembly, the chamber comprising an inlet disposed on the front and a wall near the back, the chamber configured to receive a pipe comprising an end and a diameter through the inlet and position the end abutting the wall;
a spring loaded down facing double blade configured to imprint a double mark on the pipe, such that the distance between any point between the double mark and the end is no less than a critical distance corresponding to the diameter.

2. A pipe marker as in claim 1, further comprising:
a C-shaped trigger comprising a base, arms extending from the base and terminating in downward facing flanges, slots disposed near and substantially parallel to the flanges;
a guide bar integral with the down facing double blade, wherein the slots configured to receive the guide bar therein and push upon the guide bar;
a spring holder disposed on the top;
a spring comprising a proximate end and a distal end, wherein the proximate end abutting the base and the spring holder receiving the distal end;
a pair of symmetrical guide channels disposed in the sides, the guide channels configured to receiving and guiding the guide bar therein;
a pair of symmetrical recesses disposed near and parallel to the sides, the recesses configured to slidably receiving the arms therein.

3. A pipe marker as in claim 2, wherein the guide channels further comprising a plurality of detents and wherein the inlet is shaped as an inverted teardrop, such that the pipe abutting the narrowest portion of the inverted teardrop permits each detent to position the down facing double blade to imprint the double mark at no less than the critical distance corresponding to the diameter.

4. A pipe marker as in claim 3, further comprising a window disposed near and along the wall, the window permitting observing the end abutting the wall.

5. A pipe marker as in claim 4, wherein the guide bar is a reversable member further comprising an up facing double blade disposed symmetrically to the down facing double blade on the guide bar.

6. A pipe marker as in claim 5, wherein the down facing double blade and the up facing double blade are serrated.
